(19) United States
(12) Patent Application Publication
(10) Pub. No.: US 2025/0175047 A1
(43) Pub. Date: May 29, 2025

(54) Rotor having a Surface Magnet

(71) Applicant: Robert Bosch GmbH, Stuttgart (DE)

(72) Inventors: Robert Bonasewicz, Mt. Prospect, IL (US); Thomas Pagoni, Filderstadt (DE); Marco Eitzert, Schwenningen (DE); Fabian Langbein, Plochingen (DE); Simon Mensak, Ludwigsburg (DE)

(21) Appl. No.: 18/694,968

(22) PCT Filed: Aug. 12, 2022
(86) PCT No.: PCT/EP2022/072663

§ 371 Date: Mar. 23, 2024

(30) Foreign Application Priority Data
Oct. 5, 2021 (DE) 10 2021 211 196.3

(51) Int. Cl. H02K 1/28; H02K 1/2733; H02K 7/14

(52) U.S. Cl. CPC H02K 1/28; H02K 1/2733; H02K 7/145

(57) ABSTRACT

A rotor for a drive motor having a rotor core on the outer circumference of which a surface magnet is arranged, wherein a reinforcing sleeve is arranged on an outer circumference of the surface magnet for fixing the surface magnet to the rotor core.

### PRIOR ART

The present invention relates to a rotor for a drive motor having a rotor core on the outer circumference of which a surface magnet is arranged.

From the prior art, such a rotor is known for a drive motor. The rotor comprises a rotor core, on the outer circumference of which a surface magnet is arranged. The surface magnet is attached to the outer circumference of the rotor core by means of an adhesive connection.

### DISCLOSURE OF THE INVENTION

The invention relates to a rotor for a drive motor having a rotor core, on the outer circumference of which a surface magnet is arranged. A reinforcing sleeve for fixing the surface magnet to the rotor core is arranged at an outer circumference of the surface magnet.

The invention thus enables the provision of a rotor for which a secure and reliable fixation of the surface magnet to the rotor core can be enabled by the reinforcing sleeve. Moreover, the surface magnet may be attached to the rotor core, e.g. by means of an adhesive connection. Thus, safe operation of the rotor can be enabled, in which unwanted destruction of the rotor due to the surface magnet or portions of the surface magnet disengaging from the rotor core can be effectively prevented. The reinforcing sleeve allows centrifugal protection of the surface magnet, thereby providing a robust arrangement of the surface magnet on the rotor core.

Preferably, the reinforcing sleeve is connected to the surface magnet via a force fit, form fit, and/or material connection.

Thus, fixation of the reinforcing sleeve to the surface magnet can be enabled in a simple manner.

Preferably, the reinforcing sleeve is comprised of brass, stainless steel, aluminum, and/or plastic.

Thus, a robust reinforcing sleeve having a comparatively low permeability number can be provided, thereby preventing a short circuit of a magnetic field generated by the surface magnet.

The surface magnet is preferably configured as a ring magnet and the reinforcing sleeve comprises a cylindrical base body.

Thus, the provision of a suitable surface magnet and a matching reinforcing sleeve can be enabled in a simple manner.

According to one embodiment, the surface magnet is formed by at least two circular segment-shaped magnetic segments or at least two annular magnetic segments and the reinforcing sleeve comprises a cylindrical base body.

Thus, an alternative surface magnet, as well as an alternative reinforcing sleeve, can easily and simply be provided.

Preferably, the surface magnet is formed by at least two annular magnetic segments and the reinforcing sleeve is formed by at least two cylindrical sleeve segments, wherein the at least two annular magnetic segments and the at least two cylindrical sleeve segments are arranged adjacent to one another along a longitudinal extension of the rotor.

Thus, an alternative surface magnet having an alternative reinforcing sleeve may be provided in a simple manner.

The surface magnet is preferably formed by at least two circular segment-shaped magnetic segments and the reinforcing sleeve is formed by at least two circular segment-shaped sleeve segments, wherein the at least two circular segment-shaped magnetic segments and the at least two circular segment-shaped sleeve segments are arranged adjacent to one another in the circumferential direction of the rotor.

Thus, a further embodiment of the surface magnet and the reinforcing sleeve can be enabled.

According to one embodiment, the surface magnet is formed by at least two circular segment-shaped magnetic segments and the reinforcing sleeve is formed by at least two cylindrical sleeve segments, wherein the at least two circular segment-shaped magnetic segments are arranged adjacent to one another in the circumferential direction of the rotor, and the at least two cylindrical sleeve segments are arranged adjacent to one another along a longitudinal extension of the rotor.

Thus, the provision of a further suitable surface magnet and a matching reinforcing sleeve can be enabled in a simple manner.

Preferably, the surface magnet is formed by at least two annular magnetic segments and the reinforcing sleeve is formed by at least two circular segment-shaped sleeve segments, wherein the at least two annular magnetic segments are arranged adjacent to one another along a longitudinal extension of the rotor, and the at least two circular segment-shaped sleeve segments are arranged adjacent to one another in the circumferential direction of the rotor.

Thus, an alternative surface magnet and an alternative reinforcing sleeve can easily and simply be provided.

Preferably, the rotor core is configured as a laminated core.

A stable and robust rotor core can thus be provided.

According to one embodiment, the reinforcing sleeve has a wall thickness that is at most 20% of a wall thickness of the surface magnet.

Thus, an reinforcing sleeve of sufficiently large wall thickness can be provided that securely and reliably attaches the surface magnet to the rotor core.

The present invention further relates to a drive motor having a stator and a rotor, wherein the rotor comprises a rotor core, on the outer circumference of which a surface magnet is arranged. A reinforcing sleeve for fixing the surface magnet to the rotor core is arranged at an outer circumference of the surface magnet.

The invention thus enables a drive motor having a rotor to be provided, in which a secure and reliable fixation of the surface magnet to the rotor core can be enabled by the reinforcing sleeve. Moreover, the surface magnet may be attached to the rotor core, e.g. by means of an adhesive connection. Thus, safe operation of the drive motor having a rotor can be enabled in which undesirable destruction of the rotor due to the surface magnet, or portions of the surface magnet, detaching from the rotor core can be effectively prevented.

The present invention further relates to an electrical consumer, in particular to a power tool, a hand-held power tool, a household appliance, or an garden tool, having a drive motor comprising a stator and a rotor, wherein the rotor comprises a rotor core, on the outer circumference of which a surface magnet is arranged. A reinforcing sleeve for fixing the surface magnet to the rotor core is arranged at an outer circumference of the surface magnet.

The invention thus enables the provision of an electrical consumer having a drive motor comprising a rotor in which a safe and reliable fixation of the surface magnet to the rotor core can be enabled by the reinforcing sleeve. Moreover, the surface magnet may be attached to the rotor core, e.g. by means of an adhesive connection. Thus, safe operation of the electrical consumer having the drive motor comprising a rotor may be facilitated, in which unwanted destruction of the rotor due to the surface magnet, or portions of the surface magnet, detaching from the rotor core can be effectively prevented.

Preferably, a battery pack is provided for supplying power independently of the mains, or a power cable is provided for supplying power connected to the mains.

Thus, a power supply of the electrical consumer can be safely and reliably enabled.

### BRIEF DESCRIPTION OF THE DRAWINGS

The invention is explained in further detail in the following description with reference to exemplary embodiments shown in the drawings. The figures show:

FIG. 1 a schematic view of an electrical consumer shown as a hand-held power tool having a drive motor comprising a rotor according to the invention,

FIG. 2 a perspective view of the rotor of FIG. 1,

FIG. 3 a perspective view of the rotor of FIG. 1 according to an alternative embodiment,

FIG. 4 a perspective view of the rotor of FIG. 1 according to an alternative embodiment,

FIG. 5 a perspective view of the rotor of FIG. 1 according to an alternative embodiment, and

FIG. 6 a perspective view of the rotor of FIG. 1 according to an alternative embodiment.

### DESCRIPTION OF THE EXEMPLARY EMBODIMENTS

Elements having the same or a comparable function are provided with the same reference characters in the drawings and are described in detail only once.

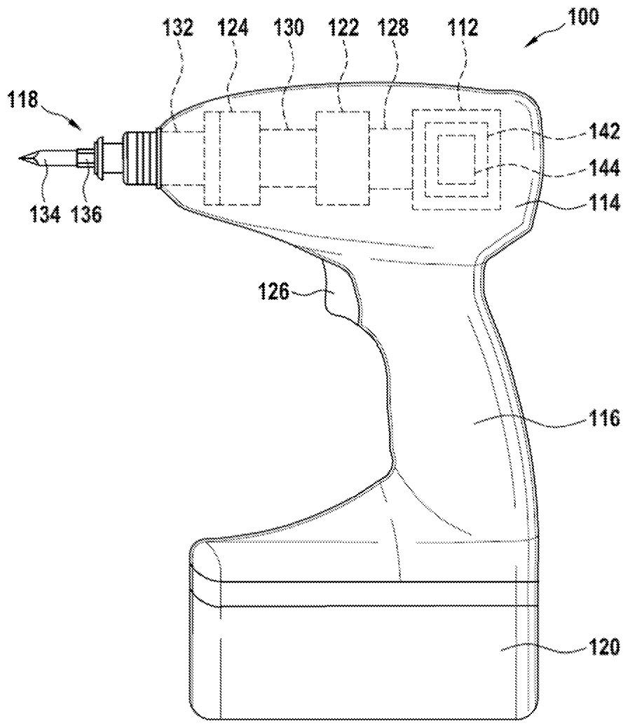

FIG. 1 shows an example of an electrical consumer 100 implemented as a hand-held power tool having a drive motor 112. The drive motor 112 is preferably implemented as an electronically commutated motor or brushless drive motor. Particularly preferably, the drive motor 112 is a brushless DC motor or a brushless AC motor.

In the context of the invention the term “electrical consumers” is intended to mean, for example, power tools operated by means of an exchangeable energy storage device, in particular an exchangeable battery pack, for processing workpieces by means of an electrically driven insert tool. The power tool can in this case be designed either as a hand-held power tool, or also as a stationary electric machine tool. Typical power tools in this context include hand or bench drills, screwdrivers, percussion drills, hammer drills, planers, angle grinders, orbital sanders, polishing machines, circular saws, table saws, crosscut saws and jigsaws, or the like. However, measuring devices operated by means of an exchangeable energy storage device, in particular an exchangeable battery pack, or power cable operated measuring devices, such as rangefinders, laser leveling devices, wall scanners, etc., as well as garden and construction equipment such as lawn mowers, lawn trimmers, branch saws, motor and trench cutters, robot breakers and excavators or the like can also be considered as electrical consumers. Electromotor driven road and rail vehicles as well as aircraft and ships or boats may also be understood under the term “electrical consumers.” Furthermore, the invention is applicable to three-phase electric motors of household appliances such as vacuum cleaners, mixers, etc. The invention is also applicable to electrical consumers that are simultaneously supplied with a plurality of interchangeable battery packs in order to achieve a high operating time and/or performance.

The electrical consumer 100, illustratively implemented as a hand-held power tool, preferably comprises a housing 114 having a handle 116 as well as a tool receptacle 118 that can be driven via an output shaft 132. The hand-held power tool 100 is illustratively mechanically and electrically connected to a battery pack 120 supplying power independently of the mains. However, the electrical consumer 100 may be implemented having a power cable for supplying power dependent on the mains.

The drive motor 112, preferably powered by the battery pack 120, is arranged within the housing 114. The drive motor 112 further comprises a stator 142 and a rotor 144. Preferably, the stator 142 is configured as an external stator and the rotor 144 is configured as an internal rotor 144. Moreover, an optional transmission 122 and an optional striking mechanism 124 are illustratively associated with the drive motor 112.

The drive motor 112 can preferably be electronically controlled and/or regulated by means of an operator control element 126 such that a reversing mode and specifications for a desired rotational speed and/or torque can be achieved. The functionality and construction of the drive motor 112 is well known to the person skilled in the art, and therefore a detailed description is omitted here.

Illustratively, the drive motor 112 is connected to the optional transmission 122 by means of an associated motor shaft 128 for converting rotation of the motor shaft 128 into rotation of a drive element 130, e.g., a drive shaft, provided between the transmission 122 and the striking mechanism 124. This conversion is preferably performed such that the drive element 130 rotates relative to the motor shaft 128 at increased torque but decreased rotational speed. The optional transmission 122 is also arranged within the housing 114, for example. Alternatively, however, the drive motor 112 and the optional transmission 122 may also be arranged in a further associated housing or in separate motor and transmission housing, which in turn are arranged in the housing 114.

Furthermore, the output shaft 132 is illustratively connected to the tool receptacle 118, which is preferably configured to receive insertion tools and, according to one embodiment, is connectable to both an insertion tool having an external coupling, e.g., a screwdriver bit, and an insertion tool having an internal coupling, e.g., a socket wrench. Illustratively, the toolholder 118 is connectable to an insertion tool 134 having an outer multi-angle clutch 136 or having an insertion tool having an inner multi-angle clutch. The insertion tool 134 is implemented, for example, as a screwdriver bit having the external polygonal coupling 136, illustratively embodied as a hex coupling, arranged in the tool receptacle 118. Such a screwdriver bit is sufficiently known from the prior art, so a detailed description is omitted herein for the purpose of brevity in the description.

The electrical consumer is implemented here, for example, as a battery-powered impact wrench. It is noted, however, that the present invention is not limited to battery-powered impact wrenches or to hand-held power tools in general, but rather can be applied to various electrical consumers 100 in which an electronically commutated drive motor or a brushless drive motor, in particular a brushless DC motor or a brushless AC motor, is used with the construction of the drive motor 112.

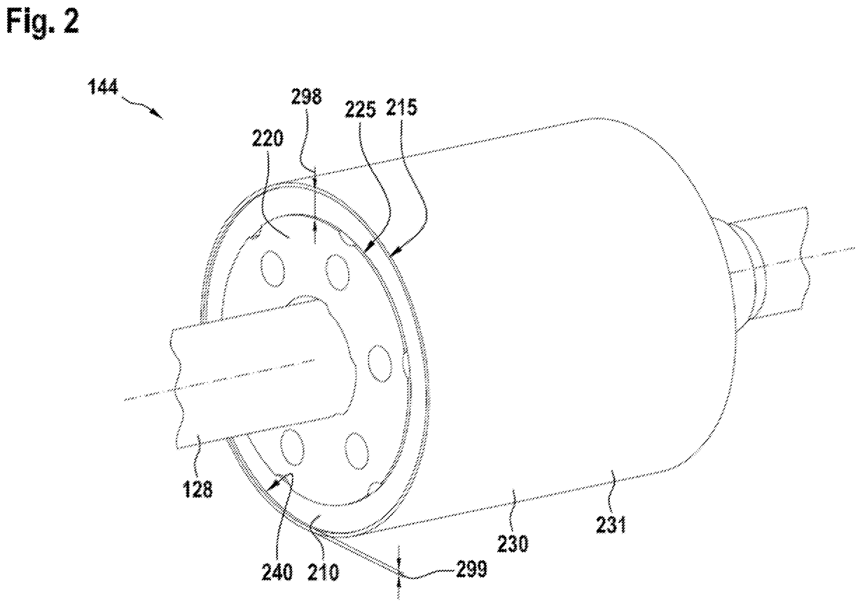

FIG. 2 shows the rotor 144 of FIG. 1 arranged on the motor shaft 128. The rotor 144 illustratively comprises a rotor core 220 having an outer circumference 225. The rotor core 220 is preferably configured as a laminated core. Such a laminated core is sufficiently known from the prior art, so a detailed description is omitted herein for the purpose of brevity in the description.

The rotor core 220 is preferably rotationally fixedly connected to the motor shaft 128. A surface magnet 210 is arranged on the outer circumference 225 of the rotor core 220. According to the invention, a reinforcing sleeve 230 is arranged on an outer circumference 215 of the surface magnet 210. The reinforcing sleeve 230 fixes the surface magnet 210 to the rotor core 220. The surface magnet 210 may additionally be attached to the rotor core 220 via any other type of attachment. Preferably, the surface magnet 210 is attached to the rotor core 220 via an adhesive connection, wherein the reinforcing sleeve 230 provides protection, in particular centrifugal protection, which prevents, for example, parts broken off from the surface magnet 210 from detaching from the rotor core 220. It is noted that the reinforcing sleeve 230 is preferably not configured to attach the surface magnet 210 to the rotor core 220, but serves merely for fixing the same to the rotor core 220.

Preferably, the reinforcing sleeve 230 is connected to the surface magnet 210 via a force-fit, form-fit, and/or material connection 240. Preferably, the reinforcing sleeve 230 comprises brass, stainless steel, aluminum, and/or plastic.

According to the embodiment shown in FIG. 2, the surface magnet 210 is configured as a ring magnet. Furthermore, the reinforcing sleeve 230 illustratively comprises a cylindrical base body 231. Preferably, the reinforcing sleeve 230 has a wall thickness 299 of at most 20% of a wall thickness 298 of the surface magnet 210.

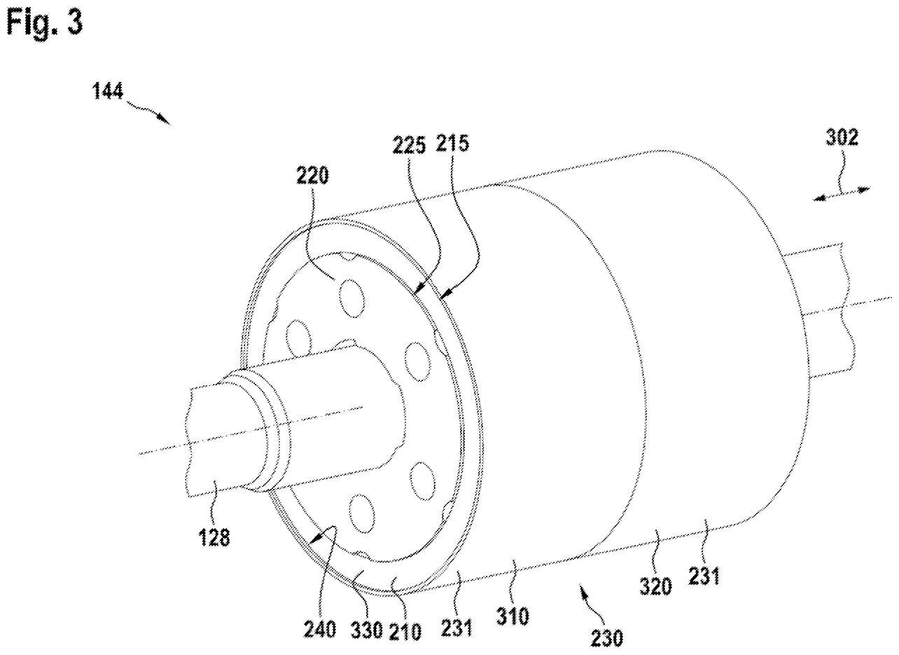

FIG. 3 shows the rotor 144 of FIG. 1 implemented according to a further embodiment. The surface magnet 210 in FIG. 3 is preferably formed by at least two annular magnetic segments 330. Analogously, the reinforcing sleeve 230 is formed by at least two cylindrical sleeve segments 310, 320. Preferably, the at least two annular magnetic segments 330 and the at least two cylindrical sleeve segments 310, 320 are each arranged adjacent to one another along a longitudinal extension 302 of the rotor 144.

Illustratively, the surface magnet 210 is formed by two annular magnetic segments 330 and the reinforcing sleeve 230 is formed by two cylindrical sleeve segments 310, 320. It is noted that the number of annular magnetic segments 330 and cylindrical sleeve segments 310, 320 may also be different.

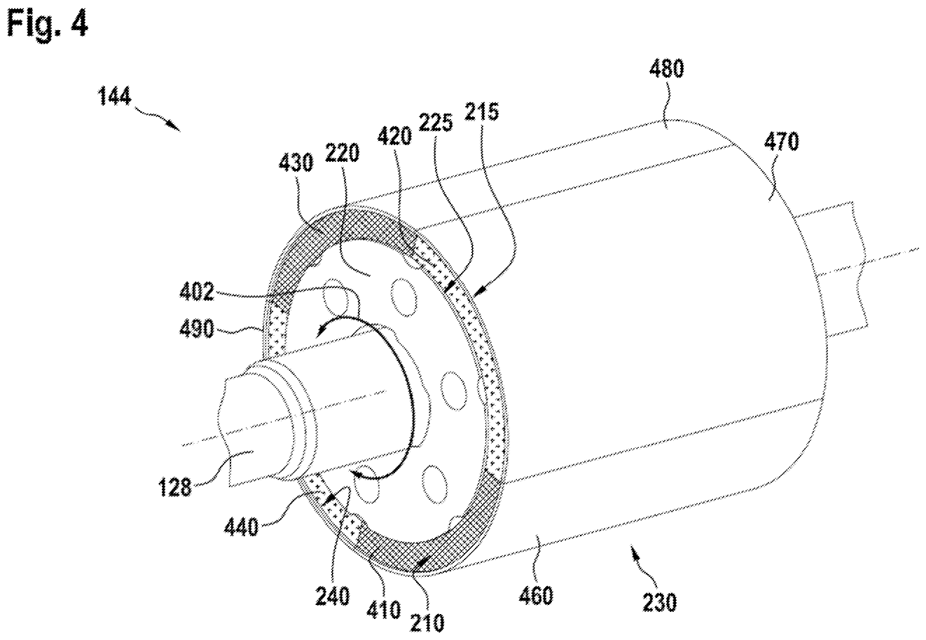

FIG. 4 shows the rotor 144 of FIG. 1 implemented according to an alternative embodiment. The surface magnet 210 is formed in FIG. 4 by at least two circular segment-shaped magnetic segments 410, 420, 430, 440. Analogously, the reinforcing sleeve 230 is preferably formed by at least two circular segment-shaped sleeve segments 460, 470, 480, 490. Preferably, the at least two circular segment-shaped magnetic segments 410, 420, 430, 440 and the at least two circular segment-shaped sleeve segments 460, 470, 480, 490 are each arranged adjacent to each other in the circumferential direction 402 of the rotor 144.

Illustratively, the surface magnet 210 is formed by four circular segment-shaped magnetic segments 410, 420, 430, 440 and the reinforcing sleeve 230 is formed by four circular segment-shaped sleeve segments 460, 470, 480, 490. It is noted that the number of circular segment-shaped magnetic segments 410, 420, 430, 440 and circular segment-shaped sleeve segments 460, 470, 480, 490 may also be different.

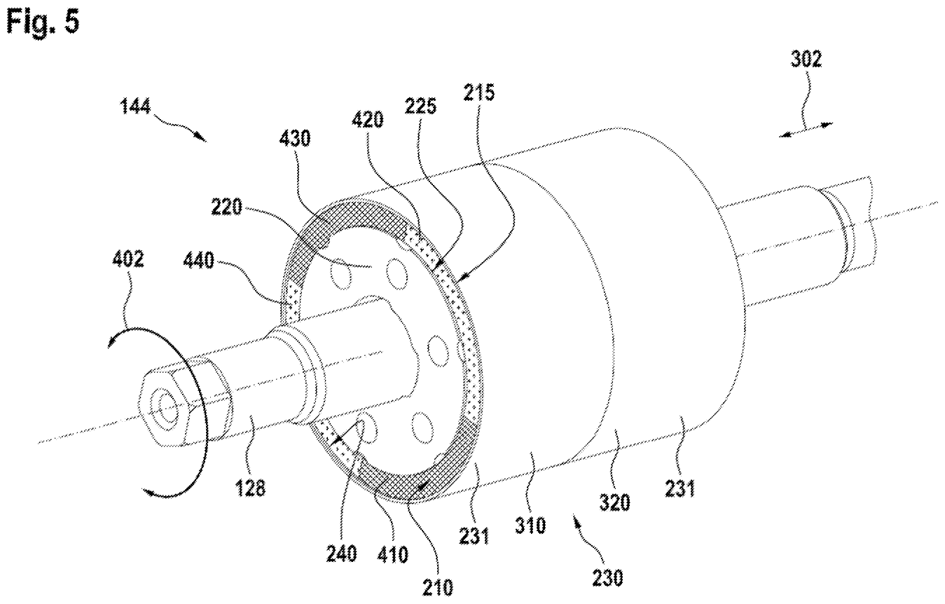

FIG. 5 shows the rotor 144 of FIG. 1 implemented according to a further alternative embodiment. The surface magnet 210 is preferably formed in FIG. 5 by at least two circular segment-shaped magnetic segments 410, 420, 430, 440, analogously to FIG. 4. Moreover, the reinforcing sleeve 230 is preferably formed by at least two cylindrical sleeve segments 310, 320 arranged adjacent to one another analogously to FIG. 3 along the longitudinal extension 302 of the rotor 144. Preferably, the at least two circular segment-shaped magnetic segments 410, 420, 430, 440 are arranged adjacent to one another in the circumferential direction 402 of the rotor 144, analogously to FIG. 4.

Illustratively, the surface magnet 210 is formed by four circular segment-shaped magnetic segments 410, 420, 430, 440 and the reinforcing sleeve 230 is formed by two cylindrical sleeve segments 310, 320. It is noted that any other number of circular segment-shaped magnetic segments 410, 420, 430, 440 and cylindrical sleeve segments 310, 320 may also be realized.

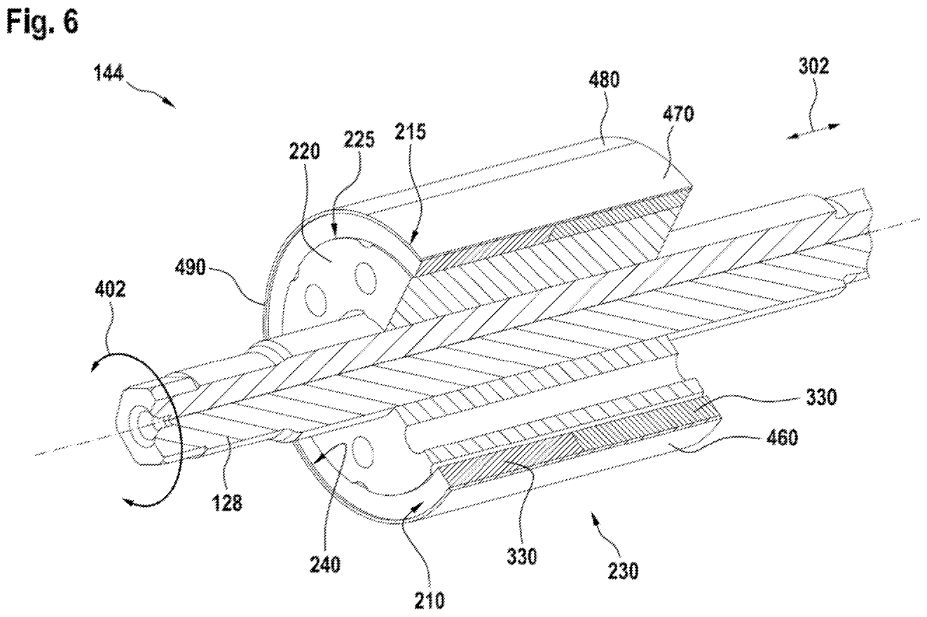

FIG. 6 shows the rotor 144 of FIG. 1 implemented according to a further alternative embodiment. The surface magnet 210 in FIG. 6 is preferably implemented by at least two annular magnetic segments 330, analogously to FIG. 3. Furthermore, the reinforcing sleeve 230 is preferably formed by at least two circular segment-shaped sleeve segments 460, 470, 480, 490, analogously to FIG. 4. In so doing, the at least two annular magnetic segments 330 are arranged adjacent to one another along the longitudinal extension 302 of the rotor 144. Preferably, the at least two circular segment-shaped magnetic segments 460, 470, 480, 490 are arranged adjacent to one another in the circumferential direction 402 of the rotor 144.

Illustratively, the surface magnet 210 is formed by two annular magnetic segments 330 and the reinforcing sleeve 230 is formed by four circular segment-shaped sleeve segments 460, 470, 480, 490. It is noted that any other number of annular magnetic segments 330 and cylindrical sleeve segments 460, 470, 480, 490 may also be realized.

Moreover, the rotor 144 may also comprise the surface magnet 210 of FIG. 2 implemented as a ring magnet, in combination with the at least two cylindrical sleeve segments 310, 320 of the reinforcing sleeve 230 of FIG. 3, or in combination with the at least two circular segment-shaped sleeve segments 460, 470, 480, 490 of the reinforcing sleeve 230 of FIG. 4.

Furthermore, the rotor 144 may also comprise the reinforcing sleeve 230 of FIG. 2 formed as a cylindrical base body 231, in combination with the at least two annular magnetic segments 330 of the surface magnet 210 of FIG. 3, or in combination with the at least two circular segment-shaped magnetic segments 410, 420, 430, 440 of the surface magnet 210 of FIG. 4.

According to a further embodiment, the surface magnet 210 may comprise at least two partial magnets arranged adjacent to each other along the longitudinal extension 302 of the rotor 144, wherein at least one partial magnet is formed as an annular magnetic segment 330 of the surface magnet 210 of FIG. 3 and at least one partial magnet comprises at least two circular segment-shaped magnetic segments 410, 420, 430, 440 of the surface magnet 210 of FIG. 4. Also, the reinforcing sleeve 230 may comprise at least two partial sleeves arranged adjacent to each other along the longitudinal extension 302 of the rotor 144, wherein at least one partial sleeve is formed as a cylindrical sleeve segment 310, 320 of the reinforcing sleeve 230 of FIG. 3 and at least one partial sleeve comprises at least two circular segment-shaped sleeve segments 460, 470, 480, 490 of the reinforcing sleeve 230 of FIG. 4. The at least two partial magnets of the surface magnet 210 and/or the at least two partial sleeves of the reinforcing sleeve 230 described above may also be combined with each other. Furthermore, the at least two partial sleeves of the surface magnet 210 described above may be combined with one of the reinforcing sleeves 230 of FIG. 2 to FIG. 6 and/or the at least two partial sleeves of the reinforcing sleeves 230 may be combined with the surface magnet 210 of FIG. 2 to FIG. 6.

1. A rotor for a drive motor, comprising:
a rotor core having an outer circumference;
a surface magnet arranged on the outer circumference of the rotor core, wherein the surface magnet also has an outer circumference; and
a reinforcing sleeve arranged on the outer circumference of the surface magnet, wherein the reinforcing sleeve is configured to fix the surface magnet to the rotor core.

2. The rotor according to claim 1, wherein the reinforcing sleeve is connected to the surface magnet by way of a force-fit, form-fit, and/or material connection.

3. The rotor according to claim 1, wherein the reinforcing sleeve is made of brass, stainless steel, aluminum, and/or plastic.

4. The rotor according to claim 1, wherein the surface magnet is implemented as a ring magnet and the reinforcing sleeve comprises a cylindrical base body.

5. The rotor according to claim 1, wherein:
the surface magnet is formed by at least two circular segment-shaped magnetic segments or at least two annular magnetic segments, and
the reinforcing sleeve comprises a cylindrical base body.

6. The rotor according to claim 1, wherein:
the surface magnet is formed by at least two annular magnetic segments,
the reinforcing sleeve is formed by at least two cylindrical sleeve segments, and
the at least two annular magnetic segments and the at least two cylindrical sleeve segments are arranged adjacent to one another along a longitudinal extension of the rotor.

7. The rotor according to claim 1, wherein:
the surface magnet is formed by at least two circular segment-shaped magnetic segments,
the reinforcing sleeve is formed by at least two circular segment-shaped sleeve segments, and
the at least two circular segment-shaped magnetic segments and the at least two circular segment-shaped sleeve segments are arranged adjacent to one another in the circumferential direction of the rotor.

8. The rotor according to claim 1, wherein:
the surface magnet is formed by at least two circular segment-shaped magnetic segments, and
the reinforcing sleeve is formed by at least two cylindrical sleeve segments, wherein
the at least two circular segment-shaped magnetic segments are arranged adjacent to each other in the circumferential direction of the rotor, and
the at least two cylindrical sleeve segments are arranged adjacent to each other along a longitudinal extension of the rotor.

9. The rotor according to claim 1, wherein:
the surface magnet is formed by at least two annular magnetic segments,
the reinforcing sleeve is formed by at least two circular segment-shaped sleeve segments,
the at least two annular magnetic segments are arranged adjacent to one another along a longitudinal extension of the rotor, and
the at least two circular segment-shaped sleeve segments are arranged adjacent to one another in the circumferential direction of the rotor.

10. The rotor according to claim 1, wherein the rotor core is formed as a laminated core.

11. The rotor according to claim 1, wherein the reinforcing sleeve has a wall thickness of at most 20% of a wall thickness of the surface magnet.

12. A drive motor having a stator and a rotor, wherein the rotor comprises a rotor core on the outer circumference of which is arranged a surface magnet, and wherein a reinforcing sleeve for fixing the surface magnet to the rotor core is arranged on an outer circumference of the surface magnet.

13. An electrical consumer having a drive motor, comprising a stator and a rotor, wherein the rotor comprises a rotor core on the outer circumference of which a surface magnet is arranged, and wherein a reinforcing sleeve is arranged on an outer circumference of the surface magnet for fixing the surface magnet to the rotor core.

14. The electrical consumer according to claim 13, wherein a battery pack is provided for supplying power independently of the mains, or a power cable is provided for supplying power connected to the mains.

15. The electrical consumer according to claim 13, wherein the electrical consumer is a power tool, a hand-held power tool, a household appliance or a garden tool.
